(19) United States
(12) Patent Application Publication
(10) Pub. No.: US 2010/0251819 A1
(43) Pub. Date: Oct. 7, 2010

(54) DAMPING DEVICE

(76) Inventor: Reinhard NEUL, Stuttgart (DE)

Correspondence Address: KENYON & KENYON LLP, ONE BROADWAY, NEW YORK, NY, 10004, US

(21) Appl. No.: 12/724,064

(22) Filed: Mar. 15, 2010

(30) Foreign Application Priority Data
Apr. 1, 2009 (DE) 102009002068.3

(51) Int. Cl. G01C 19/56

(52) U.S. Cl. 73/504.12

(57) ABSTRACT

A device for damping a movement of a seismic mass of a micromechanical inertial sensor, the device being designed to apply a force to the seismic mass damping the movement of the seismic mass as a function of the values of at least one movement parameter of the seismic mass, the damping being produced electrically.

### FIELD OF THE INVENTION

The present invention relates to a damping device, in particular a device for damping a movement of a seismic mass of a micromechanical inertial sensor.

### BACKGROUND INFORMATION

In microsystems technology, components having dimensions in the micrometer range interact in systems (Micro-Electro-Mechanical Systems [MEMS]) for extremely diverse applications. Such micromechanical systems generally have one or a plurality of sensors and actuators as well as control electronics.

The use of micromechanical systems is conceivable wherever sensors or actuators and electronics interact. One of the largest areas of application is inertial sensors such as, e.g., gyroscope sensors, acceleration sensors, and inclination sensors. Among other things, they are used in motor vehicles for the deployment of airbags and for skidding and rollover detection.

A large segment in the field of inertial sensors is represented by pure acceleration sensors which are usually used to detect linear accelerations. Often such acceleration sensors are manufactured from silicon. Such sensors are generally spring-mass systems in which the “springs” are silicon webs of only a few μm in width and the so-called seismic mass, i.e., the mass element exposed to the acceleration to be detected, is also made of silicon. The deflection of the seismic mass in acceleration makes it possible to measure a change in the electrical capacitance between the spring-suspended part and a fixed reference electrode. They are used, e.g., for the deployment of airbags in motor vehicles. An overview of current manufacturing techniques may be found, e.g., in H.-P. Trah, R. Müller-Fiedler, Mikrosystemtechnik im Automobil [Microsystem Technology in the Automobile], Physik Journal 1 (2002), No. 11, pp. 39-44.

Yaw rate sensors (also known as rotational speed sensors) represent another large area in the field of inertial sensors. Single-axis or multiple-axis micromechanical yaw rate sensors are used for extremely diverse applications (in motor vehicles, e.g., for ESP, and navigation and rollover sensing (ROSE); in the consumer segment, e.g., for image stabilization, motion detection, and navigation). A current implementation form of such sensors uses the Coriolis effect: A mass supported by springs is caused to oscillate in a first direction by a drive mechanism, causing a Coriolis effect to act on the mass if a rate of rotation in a second direction is present. This force acts perpendicularly to both the drive direction and the rate of rotation present and, for example, causes the mass to move or oscillate in this third direction.

Micromechanical inertial sensors are normally implemented as oscillating spring-mass damper systems. The pure acceleration sensors in particular are frequently equipped with gas damping through a gas inclusion having a specific internal pressure in the sensor cavity, which favorably influences the transient response of the measuring elements. An oscillator used as an acceleration sensor requires a low mechanical quality for its intended operation. Furthermore, adequate mechanical damping favors the clipping behavior of an acceleration sensor in the case of an overload. In contrast, a rotational speed sensor is normally operated at low internal pressure in the sensor cavity and accordingly with a high mechanical quality. This makes lower drive powers necessary, more selective operation with respect to interference accelerations is achieved, and the electromechanical noise of the sensor element is lower. Thus, different qualities and accordingly different internal pressures in the sensor cavity are needed in acceleration and yaw rate sensors for optimal operation.

If it is desired to accommodate yaw rate and acceleration sensor cores together in one micromechanical cavity, this gives rise to the problem that the acceleration sensor requires a low mechanical quality, i.e., a high internal pressure for its intended operation, while the yaw rate sensor requires a high mechanical quality, i.e., a low internal pressure. A similar problem arises in the case of acceleration sensors if capping technologies are to be used that initially favor a low internal pressure and a gas filling must be provided later involving additional complexity.

### SUMMARY OF THE INVENTION

The present invention provides a device which overcomes the aforementioned limitations. According to the present invention, a device for damping a movement of a seismic mass of a micromechanical inertial sensor is provided, which is designed to apply a force to the seismic mass damping the movement of the seismic mass as a function of the values of at least one movement parameter of the seismic mass, the damping being produced electrically, i.e., electrostatically and/or electromagnetically and/or piezoelectrically.

The device of the present invention advantageously makes it possible to situate acceleration and yaw rate sensor cores in a common sensor cavity having damping actions optimally adjustable for both sensor types. This is not feasible in conventional pure gas damping. Preferably, the present invention therefore replaces the gas damping by an electrostatic, electromagnetic and/or piezoelectric damping, so that in each case the internal pressure used in the sensor cavity is as low as possible and the damping and accordingly the resulting quality of the oscillating structures is produced by suitably regulated forces. Furthermore, the advantage exists that in the case of acceleration sensors in technologies favoring low internal pressures in the sensor cavity, no additional gas filling is necessary if the damping adjustment techniques of the present invention are used. In acceleration sensors, the techniques for damping adjustment according to the present invention are readily usable in normal operation. If, in the case of an overload, the forces that these techniques according to the present invention produce (in particular the electrostatic negative feedback forces) should be exceeded by the need for damping, the possibility exists to miniaturize the sensor elements further. Adequate miniaturization of seismic masses and distances in the electrostatic damping structures thus makes it possible to operate even high-G acceleration sensors (e.g., for airbag applications) having favorable clipping properties.

### BRIEF DESCRIPTION OF THE DRAWINGS

FIG. 1 shows a first specific embodiment of the device according to the present invention.

FIG. 2 shows a second specific embodiment of the device according to the present invention.

FIG. 3a shows a third specific embodiment of the device according to the present invention.

FIG. 3b shows a fourth specific embodiment of the device according to the present invention.

FIG. 3c shows a fifth specific embodiment of the device according to the present invention.

### DETAILED DESCRIPTION

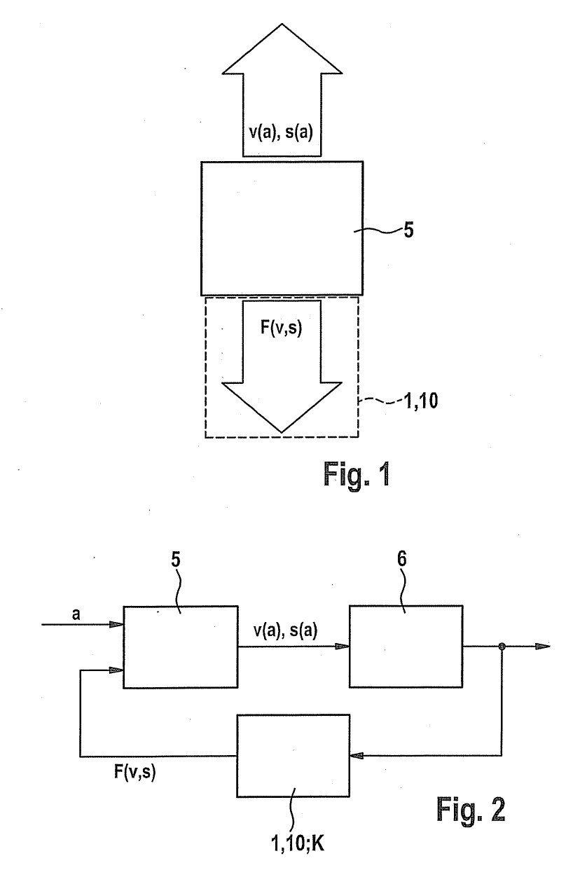

FIG. 1 schematically shows the incorporation of a first specific embodiment of device 1 of the present invention for damping a movement of a seismic mass 5 of a micromechanical inertial sensor 7, 8 into a micromechanical system. As denoted by the shaded block, device 1 is designed to apply a force F(v, s) to seismic mass 5 damping the movement of seismic mass 5 as a function of the values of at least one movement parameter v(a), s(a) of seismic mass 5. The damping takes place electrostatically and/or electromagnetically and/or piezoelectrically.

Preferably, the movement of seismic mass 5 to be damped is the movement caused by acceleration a to which inertial sensor 7, 8 is exposed. This movement is different, for example, from the driven oscillation of a yaw rate sensor which represents a reference direction for a yaw rate to be measured utilizing the Coriolis effect. Possible examples of a movement parameter are deflection s(a) of seismic mass 5 caused by acceleration a of inertial sensor 7, 8 and/or speed v(a) of deflection s(a) of seismic mass 5 caused by acceleration a of inertial sensor 7, 8.

At the same time, it is possible that the relationship between force F(v, s) damping the movement of seismic mass 5 and the values of at least one movement parameter v(a), s(a) is provided by the physical mechanism of the damping itself. In the case of electrostatic damping, it is, for example possible that equidirectionally charged moving and damping structures repel one another with increasing intensity as they become closer to one another with the result that damping force F(v, s) “automatically” becomes greater as deflection s(a) increases. The variation of damping force F(v, s) thus automatically follows physical laws such as, for example, the laws of electrostatics.

However, it is just as possible that device 1 of the present invention additionally includes a detection device 6 which is designed to actively detect at least one of the aforementioned movement parameters v(a), s(a) of seismic mass 5. It is possible to implement damping profiles that go beyond the possibilities of the initially described automatic negative feedback damping setting via a damping device 10 which is designed to apply a damping force F(v, s) to seismic mass 5 damping the movement of seismic mass 5 as a function of the detected values of at least one detected movement parameter v(a), s(a).

If damping force F(v, s) is a function of deflection s(a) of seismic mass 5 caused by acceleration a of inertial sensor 7, 8, it is recommended that damping force F(v, s) increase in direct proportion to the increase in deflection s(a) of seismic mass 5 caused by acceleration a of inertial sensor 7, 8. This prevents an overload of inertial sensor 7, 8. It is in particular possible, for example, that damping force F(v, s) is proportional to deflection s(a) of seismic mass 5 caused by acceleration a of inertial sensor 7, 8. It is in particular advantageous if damping force F(v, s) is proportional to the square of deflection s(a) of seismic mass 5 caused by acceleration a of inertial sensor 7, 8. This may be implemented in a manner which is simple in particular through the electrostatic damping already described above, as the force between two electrically charged bodies is inversely proportional to the square of the (growing) distance between the two bodies, or the force between both bodies grows quadratically with the reduction of the distance.

In a similar manner, if damping force F(v, s) is a function of the instantaneous speed of the deflection movement of seismic mass 5 caused by acceleration a of inertial sensor 7, 8, it is advantageous that damping force F(v, s) increases in direct proportion to the instantaneous speed of the deflection movement of seismic mass 5 caused by acceleration a of inertial sensor 7, 8. For example, damping force F(v, s) may be proportional to instantaneous deflection speed v(a) of the deflection movement of seismic mass 5 caused by acceleration a of inertial sensor 7, 8. It is also possible that damping force F(v, s) may be proportional to the square of instantaneous deflection speed v(a) of the deflection movement of seismic mass 5 caused by acceleration a of inertial sensor 7, 8.

In a second specific embodiment of the device according to the present invention, FIG. 2 shows a block diagram of a preferred regulation of damping force F(v, s). This regulation is based on negative feedback operation of a sensor element 7, 8 designed as a spring-mass damper system whose seismic mass 5 is exposed to acceleration a to be measured. This acceleration a causes a deflection movement of seismic mass 5 in the sensor element. Various parameters of the deflection movement, for example, deflection s(a) and/or speed v(a) of deflection s(a) of seismic mass 5, are detected by detection device 6. The detected values of the deflection movement are transferred from detection device 6 to damping device 1, 10, which, via a compensator K, generates a force F(v, s) which acts in the opposite direction to the instantaneous deflection movement of seismic mass 5. Damping device 1, 10 then applies this additional damping force F(v, s) to seismic mass 5. This damping force may be applied to seismic mass 5 electrostatically, piezoelectrically and/or electromagnetically.

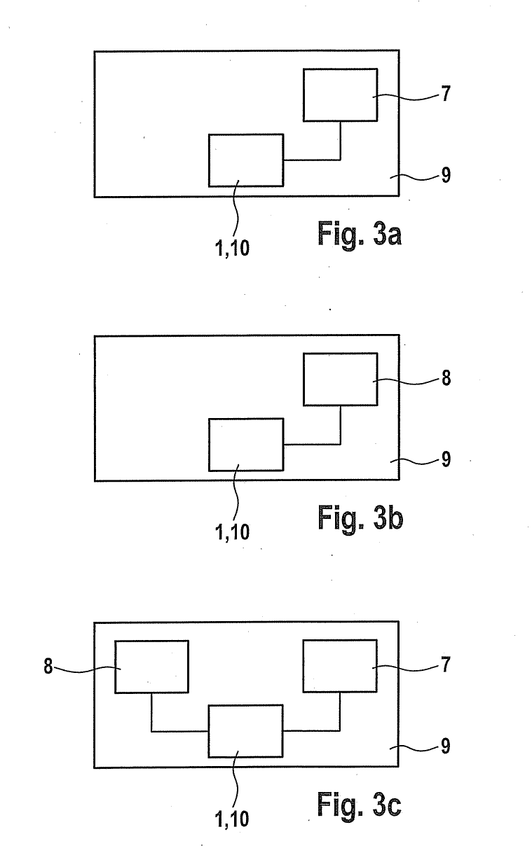

In a third specific embodiment of the device according to the present invention, FIG. 3a shows an implementation having an acceleration sensor 7 and a damping device 1, 10 acting on it which is located in a sensor cavity 9. In the event acceleration sensors 7 are used, forces are applied to seismic mass 5 by negative feedback via suitable compensators. Suitable compensators include types PDT₁ and PIDT₁, PT₂; however, more complex types are also possible. The low damping of an oscillating structure enclosed at a low gas pressure is thus increased to such a degree that an optimized transient response is achieved. Since it is also normally desired to detect DC signals using acceleration sensors, electrostatic and electromagnetic forces may be considered for the negative feedback in the case of acceleration sensors in particular.

In a fourth specific embodiment of the device according to the present invention, FIG. 3b shows an implementation having a yaw rate sensor 8 and a damping device 1, 10 acting on it which is located in a sensor cavity 9. When yaw rate sensors are used, Coriolis accelerations are frequently measured using acceleration sensor structures, and the yaw rates are determined from them. In this case also, forces are applied to seismic mass 5 by negative feedback via suitable compensators. Suitable compensators include, e.g., types DT₁ and PT₂; however, more complex types are also possible in this case. In the case of yaw rate sensors having these compensators, the mechanical quality of the oscillators is reduced to such an extent that the resonance curve reaches such a bandwidth that at least the desired measuring bandwidth of the yaw rate sensors is reached. The frequency of the resonance sharpness is influenced as little as possible. As it is only desired to detect Coriolis accelerations in the frequency range in the vicinity of their oscillation frequency, it is unnecessary to detect DC signals, making electrostatic, electromagnetic and piezoelectric forces well suited for the negative feedback in this case.

In a fifth specific embodiment of the device according to the present invention, FIG. 3c shows an implementation having an acceleration sensor 7 and a yaw rate sensor 8, as well as a damping device 1, 10 acting on both which are located together in a sensor cavity 9. Cavity 9 preferably has an internal pressure which is as small as possible, ideally no internal pressure, so that no or only very slight gas damping of the sensor elements occurs. The electrostatic, electromagnetic and/or piezoelectric damping of the present invention thus makes it possible to achieve optimally adjustable damping for both sensor types.

What is claimed is:

1. A device for damping a movement of a seismic mass of a micromechanical inertial sensor, comprising:
an arrangement for applying a force to the seismic mass damping the movement of the seismic mass as a function of values of at least one movement parameter of the seismic mass, the damping being produced at least one of electrically, electrostatically, electromagnetically and piezoelectrically.

2. The device according to claim 1, wherein a relationship between the force damping the movement of the seismic mass and the values of the at least one movement parameter is provided by a physical mechanism of the damping.

3. The device according to claim 1, further comprising a detection device for detecting the at least one movement parameter of the seismic mass and a damping device which is designed to apply a force to the seismic mass damping the movement of the seismic mass as a function of the detected values of the at least one detected movement parameter.

4. The device according to claim 1, wherein the movement of the seismic mass to be damped is a movement caused by an acceleration to which the inertial sensor is exposed.

5. The device according to claim 1, wherein one of the movement parameters of the seismic mass is a deflection of the seismic mass caused by an acceleration of the inertial sensor.

6. The device according to claim 5, wherein the damping force increases in direct proportion to an increase in the deflection of the seismic mass caused by the acceleration of the inertial sensor.

7. The device according to claim 5, wherein the damping force is proportional to the deflection of the seismic mass caused by the acceleration of the inertial sensor.

8. The device according to claim 5, wherein the damping force is proportional to a square of the deflection of the seismic mass caused by the acceleration of the inertial sensor.

9. The device according to claim 1, wherein one of the movement parameters of the seismic mass is a speed of a deflection of the seismic mass caused by an acceleration of the inertial sensor.

10. The device according to claim 9, wherein the damping force increases in direct proportion to an increase in the speed of the deflection of the seismic mass caused by the acceleration of the inertial sensor.

11. The device according to claim 9, wherein the damping force is proportional to the speed of the deflection of the seismic mass caused by the acceleration of the inertial sensor.

12. The device according to claim 9, wherein the damping force is proportional to a square of the speed of the deflection of the seismic mass caused by the acceleration of the inertial sensor.

13. The device according to claim 1, wherein the device is functionally coupled to a yaw rate sensor core and an acceleration sensor core.

14. The device according to claim 1, wherein the device is functionally coupled to the seismic mass of an acceleration sensor and of a yaw rate sensor.

15. The device according to claim 13, wherein the yaw rate sensor core and the acceleration sensor core are situated together in a micromechanical cavity.

16. The device according to claim 15, wherein the cavity has substantially no internal pressure, so that substantially no gas damping of sensor elements occurs.
